(19) United States
(12) Patent Application Publication
(10) Pub. No.: US 2004/0006544 A1
(43) Pub. Date: Jan. 8, 2004

(54) Integrated licensing, design, and supply system, method, and article of manufacture for semiconductor chips

(76) Inventor: Michael Gulett, Monte Sereno, CA (US)

Correspondence Address: Maureen Stretch, 26 Charles Street, Natick, MA, 01760, US

(21) Appl. No.: 10/189,162

(22) Filed: Jul. 3, 2002

(51) Int. Cl. G06F 19/00

(52) U.S. Cl. 705/400; 716/4; 700/121

(57) ABSTRACT

A system for integrated licensing, design, modification, manufacture and purchase of semiconductor products incorporating technology from two or more sources.

### BACKGROUND

1. Technical Field

This invention relates generally to the field of semiconductor chip design and manufacture and more specifically to an integrated system for enabling two or more parties to cooperate in the design, license, manufacture and sale of semiconductor chips.

In earlier days of semiconductor manufacture, as depicted in FIG. 3A (Prior Art) original equipment manufacturers (OEMs) 10, might design, develop and fabricate their own semiconductor chips using their own internal manufacturing capabilities, 10a. The chips thus produced would then be built into an OEM 10's products 05. For example, if the OEM were a computer manufacturer, products 05 might be complete computer systems sold with monitors, buses, cables, printers, etc.

As the types of semiconductor manufacturing processes grew, some companies became specialized integrated chip suppliers 20, as seen in FIG. 3B (Prior Art). In this example, an OEM 10, might purchase chips from an integrated chip supplier 20 for inclusion in OEM 10's products 05.

With the need for increased outsourcing, the fabless semiconductor model shown in FIG. 3C (Prior Art) developed. As its name implies, the fabless semiconductor chip company does not actually “fabricate” or make the chip. Instead, the fabless chip supplier 30 defines and designs the chip but a “wafer” foundry 40 manufactures the chip. (Most semiconductors are created from a wafer of semiconductive material, hence the name wafer foundry.) The wafer foundry 40 sells the chip to the fabless chip supplier 30 which then resells the chip to the OEM 10 equipment company. As a normal business practice, this typically requires a price markup of the manufacturing cost by the fabless chip supplier 30 so that by the time the OEM 10 has paid for the chip there are two companies that must have made an acceptable gross margin on their inventories (wafer foundry 40 and the fabless chip supplier 30).

As semiconductor technology became even more complex, more functionality could be integrated onto a single chip. This led to the emergence of the intellectual property (IP) business where an IP provider supplies IP (usually in the form of both technology and license rights) to a chip designer so that the full potential of modern semiconductor technology can be used. FIG. 3D (Prior Art), shows this model in operation. As seen in FIG. 3D (Prior Art), one or more additional companies, IP supplier 50, have been added to the picture. More companies can often mean more cost overall, increased complexity and increased risk.

Since semiconductor technology has evolved so rapidly, it is now possible to put more and more functionality on a chip. Where a single chip might once have contained only a central processing unit (CPU) or a digital signal processor (DSP), today it is possible to put whole Systems On a Chip, thus the term SOC. At the same time, this additional capability puts significant stress on design staffs in the examples shown in FIGS. 3A(Prior Art) through 3D(Prior Art).

One of the basic problems in the semiconductor industry is checking out a completely new design. It is both time consuming and costly to design and test a new semiconductor chip from “scratch,” as it were. The time it takes can slow down time to market, and the expense can sometimes make a product too costly for the marketplace.

While there are many development tools now available, such as Verilog and VHDL, which allow a designer to describe and design a new chip, many manufacturers prefer to use existing semiconductor products—either their own or those from third parties, when feasible, instead of designing a completely new system on a chip. For competitive advantage, though, it often makes sense for an OEM's product to be differentiated from other products that provide similar functionality. As more and more third party products are used and combined on a single chip, and then combined with the OEM's unique modifications, this increases the complexity of design verification and may raise compatibility issues.

Another trend in the electronics industry as a whole has been the increased adoption of standard interfaces and technology, such as the Universal Serial Bus (USB), IEEE'S 1394 “Firewire” bus technology, Bluetooth wireless technology, etc. While the agreement on a standard specification for such devices tells a developer how the device should operate and communicate in order to meet the standard, the specifications do not necessarily simplify the process of designing and building products that use these technologies. In fact, many of the standards describe groundrules for quite complicated devices. Thus, many developers prefer to license a device core that meets the standard and can be built-in to the rest of a system on a chip or application specific integrated circuit (ASIC), application specific standard product chips (ASSP), or programmable logic devices such as field programmable gate arrays (FPGA), etc.

As a result of these developments, today's systems on a chip may require several hardware and software components: a microprocessor cpu, on-chip peripheral devices, an operating system, protocol stacks, device drivers and application specific hardware and software. Designing all these components from scratch is not practical from either an engineering or a time-to-market standpoint.

In the past, most of these hardware components were individual devices soldered onto a printed circuit board. To increase performance and reduce costs, developers began to leverage increasingly higher levels of integration by moving board-level components onto the chip. Vendors responded by licensing component technology originally destined for stand-alone devices. This became known as the first generation of licensable intellectual property (IP). Although semiconductor companies had been re-using designs for several years, licensable IP introduced the industry as a whole to the powerful concept of re-usability.

One drawback of first-generation IP was that the components were specific to a particular foundry and process technology—often the vendor's. And because the IP components were “hard,” (that is, in circuit, hard-wired form) system designers could not modify them. They had little or no control over manufacturing or the functionality of the components. In contrast, second-generation IP, or “soft IP,” is more versatile. Vendors supply the components in the form of synthesizable Hardware Description Language (“HDL”) source code, sometimes the same HDL source used to create the first-generation IP components. Soft IP is independent of the fabrication process and foundry. It gives designers greater flexibility and control over manufacturing and production. However, even with second generation soft IP, it is still difficult to create high performance systems because designers cannot significantly modify the IP to address the growing demands of the market.

Consequently, developments in technology, standards, and rapidly changing economic conditions make the whole process of chip design, manufacture and purchase more complex and time-pressured than ever.

### DRAWINGS

FIG. 1 is a schematic drawing of the system of the present invention.

FIG. 2 is a schematic drawing showing the present invention in more detail.

FIGS. 3A(Prior Art) through 3D(Prior Art) are schematic drawings showing the prior art.

FIGS. 4-6 are flow diagrams of the present invention.

### DETAILED DESCRIPTION OF THE INVENTION

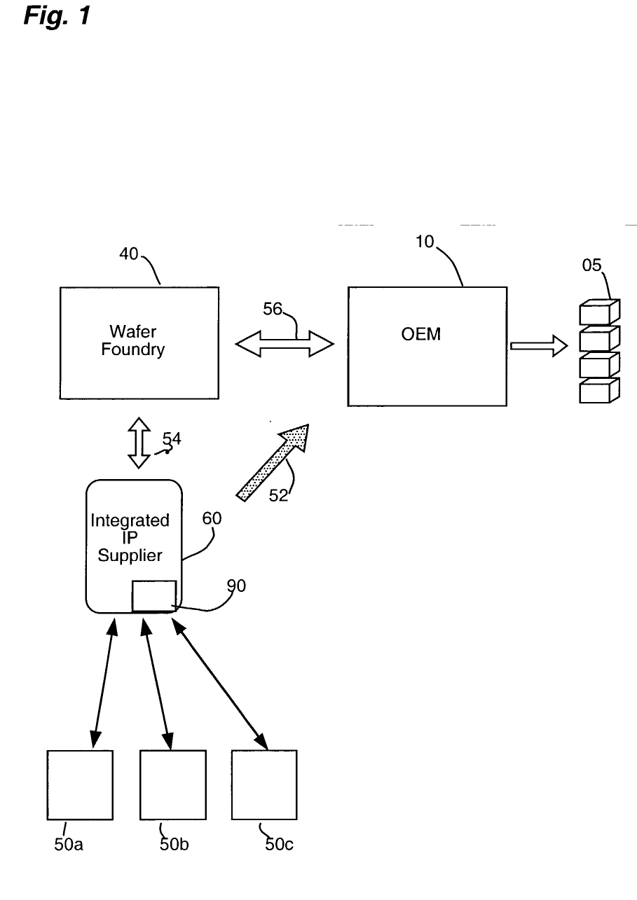

FIG. 1 shows applicant's integrated system for the design, license, manufacture and sale of semiconductor chips that use technology from two or more entities. As seen in FIG. 1, integrated IP supplier 60 maintains a semiconductor product development platform 90 for integrating designs and the licenses for them from one or more semiconductor product designers. Product development platform 90 also includes information about license terms and about calculating royalty rates for semiconductor products produced using the resulting integrated semiconductor product design. In the embodiment shown, product development platform 90 is made available to an OEM 10, in kit form, as indicated through shaded arrow 52, so that OEM 10 may customize the integrated semiconductor product design as the OEM desires or the OEM may use the completed integrated semiconductor product as defined by the integrated IP supplier.

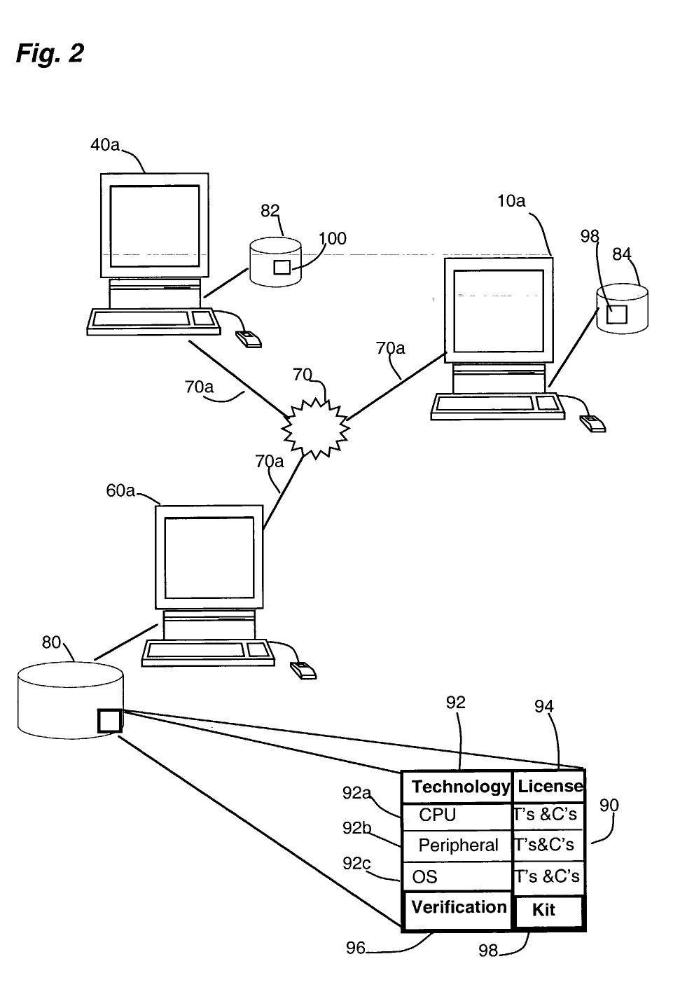

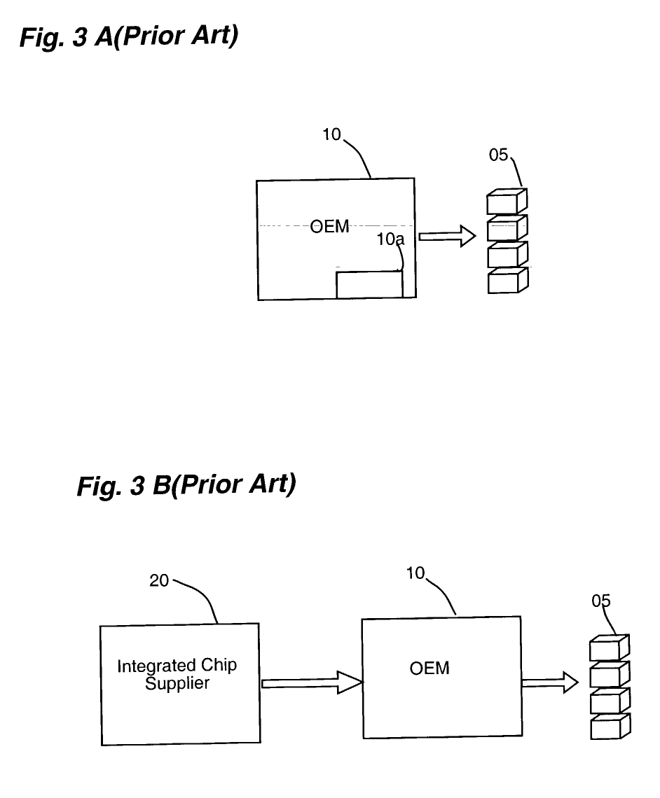

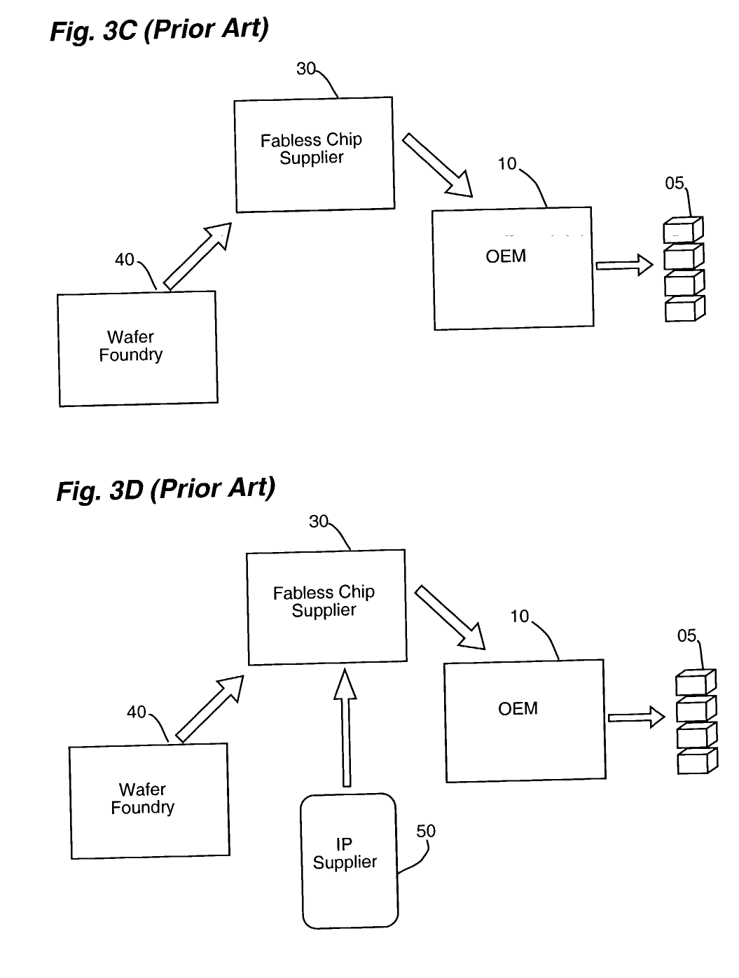

In the embodiments shown, and as can be seen more clearly in FIG. 2, semiconductor product development platform 90 includes licensable intellectual property 92 from one or more designers for the creation of semiconductor products. In the embodiments shown, this licensable intellectual property 92 has already been verified, as indicated by verification results 96, by integrated IP supplier 60 with wafer foundry 40. The verified licensable intellectual property 92, including license terms 94, can thus be supplied as a kit 98, to an OEM 10.

In the embodiment shown in FIG. 2, this kit 98 can be made available electronically, over a secure network 70, to a terminal 10a located at OEM 10. As will be apparent to those skilled in the art, terminal 10a can be anything from a simple terminal, a wireless personal data assistant, or a personal computer to a larger computer system or a computer aided design workstation. Alternatively, kit 98 can be supplied to OEM 10 on a set of CD-ROMs, disks, or similar transfer media, if a secure network is not available or if integrated IP supplier 60 or OEM 10 prefer that form.

Similarly, and still in FIG. 2, computer 60a, operating semiconductor product development platform 90 for integrated IP supplier 60, can arrange for verification of the licensable intellectual property 92 with wafer foundry 40 using a secure network 70 to communicate with a terminal 40a at the wafer foundry 40. If a secure network is not available, licensable intellectual property 92 can be supplied to wafer foundry 10 on a set of CD-ROMs, disks, or similar transfer media if either integrated IP supplier 60 or wafer foundry 40 prefer that form of communication.

In the embodiments shown, OEM 10 may modify the licensable intellectual property 92, and also add some intellectual property owned or newly created by OEM 10. In the embodiment shown, if any such changes are made, OEM 10 supplies the changes to integrated IP supplier 60, in an updated kit 98, which, in turn, goes through the verification process again with wafer foundry 10. In another embodiment shown, OEM 10 can be authorized by integrated IP supplier 60 to transmit the changes directly to wafer foundry 10, using procedures and safeguards previously agreed upon amongst the parties. These changes then again go through the verification process with wafer foundry 10.

Once final verification is complete, integrated IP supplier 60 calculates license terms and royalty rates for semiconductor products made by wafer foundry 40 for OEM 10 using this verified design. An authorization system 100 is created for wafer foundry 40 by integrated IP supplier 60 containing the authorization details. From that point on, OEM 10 may purchase semiconductor products made according to the verified design directly from wafer foundry 40. In one embodiment of the present invention shown, payments made for such products are made by OEM 10 directly to wafer foundry 40, which, in turn, remits appropriate fees and royalties to integrated IP supplier 60, which, further in turn, remits royalties, etc. to IP suppliers 50, whose products have been included in the final verified design. In an alternative embodiment shown, payments for IP suppliers 50 may be made directly from wafer foundry 40 to IP suppliers 50.

In another alternative embodiment shown, payments for the semiconductor products are made by OEM 10 directly to integrated IP supplier 60 and shipments are authorized to be made directly from wafer foundry 40 to OEM 10. In this embodiment, integrated IP supplier remits appropriate payments to wafer foundry 10 and royalties to IP suppliers 50. This embodiment may, however, create more complex reporting requirements.

As can be seen, applicant's' invention greatly simplifies the entire process for OEMs 10. An OEM 10 need only work with one, integrated IP supplier instead of with possibly several IP suppliers and a fabless chip supplier and so on. By eliminating the need for shipments of the final semiconductor product from a wafer foundry 40 to an intermediate shipper (either a fabless supplier or an IP supplier), costs can also be significantly reduced for an OEM 10. In the current market, a wafer foundry typically ships finished product to a fabless chip supplier, which then, in turn, ships finished product to an OEM 10. An intermediate usually must add inventory holding costs, shipping costs, and other costs to its sale price in order to make an acceptable gross margin. This can mean a significant increase in cost to the OEM.

Additionally, if the OEM wants to use IP from multiple IP suppliers, without the present invention the OEM would have to enter into license and payment negotiations with each IP supplier and work out technology transfer procedures with each, as well as make royalty payments to each. Thus, in order to put four components from four different IP suppliers onto one chip, the OEM might have to deal directly with at least six companies: the four IP suppliers, a fabless chip supplier and a wafer foundry.

The present invention allows significant savings in cost, time, and complexity. The integrated IP supplier 60, using semiconductor development platform 90, can provide the OEM with the flexibility of IP from various sources and yet with the simplicity of dealing with only one.

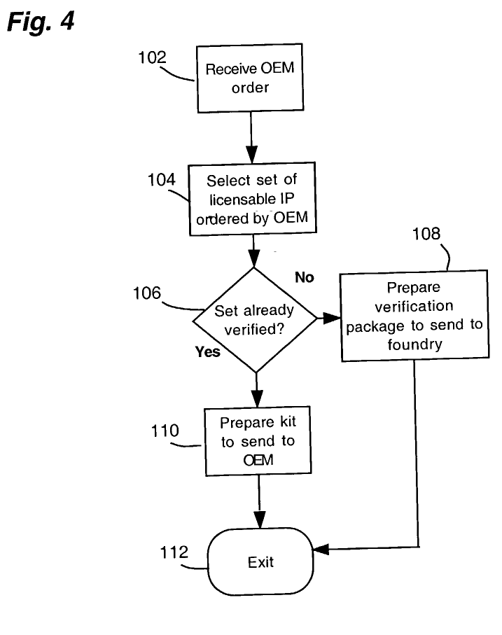

Turning now to FIG. 4, a flow diagram of the present invention is shown. At step 102, integrated IP supplier 60 receives an order from OEM 10 into integrated IP supplier 60's product development platform 90. At step 104, product development platform 90 selects the set of licensable IP ordered by OEM 10. Next, at decision block 106, the invention checks to see if the ordered set has already been verified for fabrication by a wafer foundry 10. If it has, product development platform 90 prepares a kit 98 at step 110, to send to OEM 10 for use by OEM 10 in customizing the system on a chip. If the selected set of licensable IP has not yet been verified, product development system 90 prepares a verification package 96 at step 108 to send to wafer foundry 10.

Returning briefly to FIG. 2, if verification is needed, integrated IP supplier 60 communicates with wafer foundry 10, for verification. Once a selected set is verified, a kit 98 is sent to OEM 10, if OEM 10 wishes to customize the final system. Or, as mentioned above, OEM 10 can communicate directly with integrated IP supplier 60 over secure network 70 to customize the kit 98 using integrated IP supplier 60's systems. In the embodiments shown, if OEM 10 customizes the contents of kit 98, this, in turn, may need verification, which integrated IP supplier 60 can again perform with wafer foundry 10.

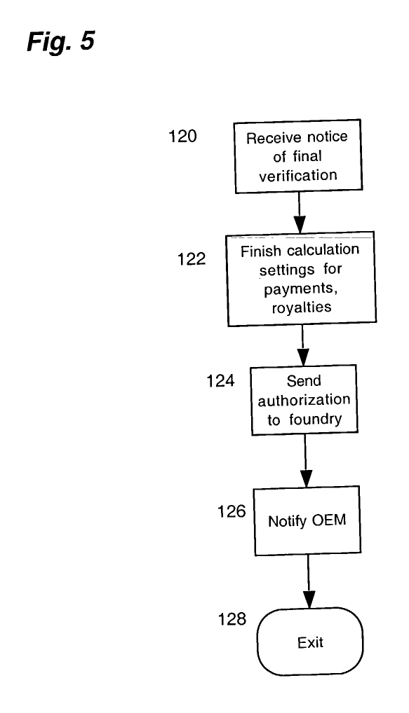

With reference now to FIG. 5, once product development platform 90 receives notification of final verification at step 120, it proceeds to step 122, to finish or otherwise update the calculation settings for payments and royalties, according to the provisions of the various IP licenses involved in the final selected and verified set of licensable IP 92. These settings, along with the final set of licensable IP 92 in a verified kit 98 are sent, at step 124, with authorization codes as part of authorization system 100 to wafer foundry 10. Next, at step 126, a notice is sent to OEM 10 informing it that products can now be purchased directly from wafer foundry 10, using the appropriate authorization codes. In the embodiments shown, the authorization codes include a code for the verified kit 98, and for OEM 10. In the embodiments shown, these codes are encrypted when sent electronically. As will be apparent to those skilled in the art, any of a number of authorization codes or schemes can be used without deviating from the spirit of the present invention.

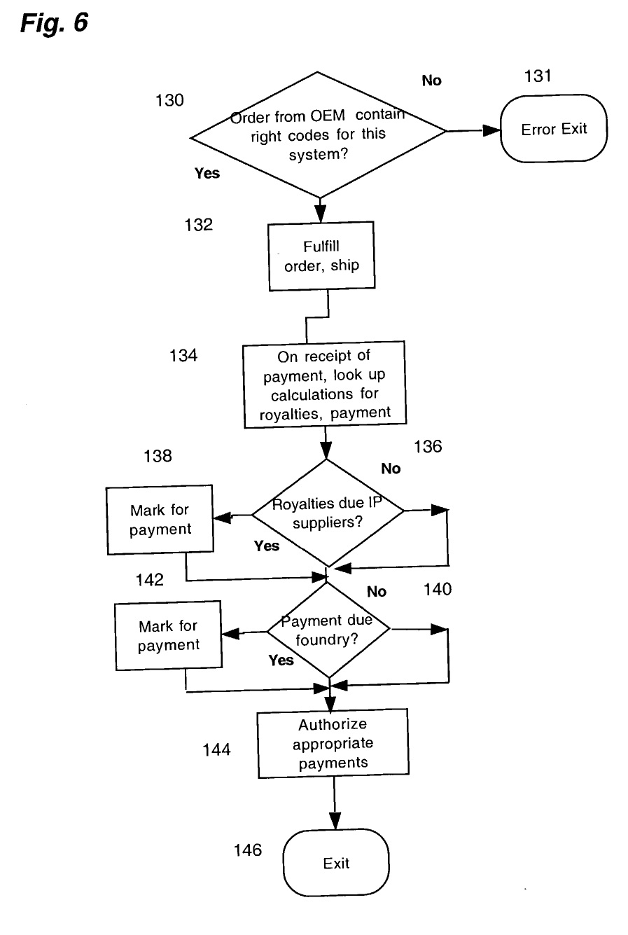

Now turning to FIG. 6, the authorization system of the present invention is shown. In the embodiments shown, authorization system 100 can be used by wafer foundry 10 to check to see if orders placed for certain licensable IP are authorized by integrated IP supplier 60. At step 130, authorization system 100 checks to see if the codes supplied with an order from an OEM are the correct codes for the verified licensable IP. If they are not, an error has occurred and processing stops at step 131. If the codes are valid, at step 132 authorization system 100 approves fulfilling and shipping the order. As will be apparent to those skilled in the art, authorization system 100 can transmit the appropriate order information to wafer foundry 10's own internal shipment and billing systems.

Still in FIG. 6, at step 134, usually after some interval, authorization system 100 of the present invention is notified that payment for the shipment has been received. Using the information prepared for the final licensable IP kit 98, authorization system 100 checks to see if royalties are due to IP suppliers at step 136. If so, at step 138 these are marked for payment and the amounts to be paid are calculated from the information supplied with authorization system 100. Next, at step 140, authorization system 100 checks to see if a payment is due to wafer foundry 10. (Note, that in an embodiment shown, authorization system 100 is actually run by wafer foundry 10 as seen in FIG. 2). If payment is due wafer foundry 10, it is marked for payment and the amounts to be paid are calculated from the information supplied with authorization system 100. Finally, at step 144 authorization system 100 authorizes the appropriate payments and exits at step 146.

In the embodiments shown, the present invention is implemented using applicant's ARCform Metaware™ integrated development platform on WINDOWS™ and WINDOWS™ NT systems, but as will be apparent to those skilled in the art, it could also be implemented in any of a number of programming languages such as JAVA, C, C++, assembler, ADA, Pascal, and any number of operating systems. Similarly, while the embodiments shown use software programs to implement the invention, those skilled in the art know that some or all of the present invention could also be implemented in firmware or circuitry without deviating from the spirit of the present invention. Those skilled in the art will appreciate that the embodiments described above are illustrative only and that other systems in the spirit of the teachings herein fall within the scope of the invention.

What is claimed is:

1. A system for the integrated licensing, design, manufacture, and purchase of a semiconductor product which incorporates technology from at least two sources, comprising:
a product development platform for integrating designs for the technologies to be included in the semiconductor product, the product development platform also storing each technology and the intellectual property information about each technology, including license terms, fees, and royalty rates for each technology in a product design kit, so that payments can be calculated automatically when orders are placed for the semiconductor product, the product development platform also supplying information for a verification package for the integrated semiconductor product, and for an authorization system;
a verification process operated by the semiconductor product manufacturer for taking the verification package supplied by the product development platform and verifying that the integrated semiconductor product it describes will work; and
an authorization system for enabling a customer to purchase the integrated semiconductor product directly from the semiconductor product manufacturer on the license terms and for the fees and royalty rates specified in the integrated product development platform.

2. The apparatus of claim 1, wherein the verification package is made available over a secure network.

3. The apparatus of claim 1, wherein the authorization package is made available over a secure network.

4. The apparatus of claim 1, wherein the product design kit is made available over a secure network.

5. A method for the integrated licensing, design, manufacture, and purchase of a semiconductor product which incorporates technology from at least two sources, comprising the steps of:
integrating designs for the technologies to be included in the semiconductor product using a product development platform, the product development platform also storing each technology and the intellectual property information about each technology, including license terms, fees, and royalty rates for each technology in a product design kit, so that payments can be calculated automatically when orders are placed for the semiconductor product, the product development platform also supplying information for a verification package for the integrated semiconductor product, and for an authorization system;
operating a verification process for the semiconductor product manufacturer for taking the verification package supplied by the product development platform and verifying that the integrated semiconductor product it describes will work; and
enabling a customer to purchase the integrated semiconductor product directly from the semiconductor product manufacturer by using an authorization system which includes the license terms and the fees and royalty rates specified in the integrated product development platform.

6. The method of claim 5, wherein the step of integrating designs further comprises the step of making the product design kit available over a network.

7. The method of claim 5, wherein the step of integrating designs further includes the step of making the verification package available over a network.

8. The method of claim 5, wherein the step of integrating designs further includes the step of making the authorization system available over a network.

9. A machine readable medium for storing a product development platform for integrating designs for technologies from at least two sources to be included in a semiconductor product, the product development platform also storing each technology and the intellectual property information about each technology, including license terms, fees, and royalty rates for each technology in a product design kit, so that payments can be calculated automatically when orders are placed for the semiconductor product, the product development platform also supplying information for a verification package for the integrated semiconductor product, and for an authorization system.

10. A machine readable medium for storing an authorization system for enabling a customer to purchase an integrated semiconductor product integrating designs for technologies from at least two sources directly from the semiconductor product manufacturer on the license terms and for the fees and royalty rates specified in an integrated product development platform which stores each technology and the intellectual property information about each technology, including license terms, fees, and royalty rates for each technology in a product design kit, so that payments can be calculated automatically when orders are placed for the semiconductor product, the product development platform also supplying information for a verification package for the integrated semiconductor product
